(19) United States
(12) Patent Application Publication
(10) Pub. No.: US 2006/0085585 A1
(43) Pub. Date: Apr. 20, 2006

(54) MAIN BOARD WITH A SLOT-SHARING CIRCUIT FOR PCI EXPRESS X16 AND X1 SLOT TO BE CONNECTED TO

(76) Inventors: Feng-Sheng Wu, Hua-Lien City (TW); Tsong-Woei Lee, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 10/904,594

(22) Filed: Nov. 18, 2004

(30) Foreign Application Priority Data
Oct. 19, 2004 (TW) 093131670

(51) Int. Cl. G06F 13/36

(52) U.S. Cl. 710/306

(57) ABSTRACT

A main board has a slot-sharing circuit for a PCI express ×16 slot and a PCI express ×1 slot to be electrically connected to, an ×16 resistor-capacitor circuit corresponding to the PCI express ×16 slot, an ×1 resistor-capacitor circuit corresponding to the PCI express ×1 slot, a slot installed on a location where the slot-sharing is installed on the main board, and a plurality of resistors and capacitors.

### BACKGROUND OF INVENTION

1. Field of the Invention

The present invention relates to a main board, and more particularly, to a main board with a slot-sharing circuit for PCI Express ×16 and ×1 slots to be connected to.

2. Description of the Prior Art

Please refer to FIG. 1, which is a schematic diagram of a main board 10 according to the prior art. The main board 10 comprises a CPU 12, a north bridge circuit 14 electrically connected to the CPU 12, a south bridge circuit 16 electrically connected to the north bridge circuit 14, an ×16 resistor-capacitor circuit 26 electrically connected to the north bridge circuit 14, a PCI Express ×16 slot circuit 18 electrically connected to the ×16 resistor-capacitor circuit 26, an ×1 resistor-capacitor circuit 28 electrically connected to the south bridge circuit 16, a PCI Express ×1 slot circuit 20 electrically connected to the ×1 resistor-capacitor circuit 28, a PCI Express ×16 slot 22 electrically connected to the PCI Express ×16 slot circuit 18 (Where the PCI Express ×16 slot circuit 18 is installed on the main board 10 is the location where the PCI Express ×16 slot 22 is installed on the main board 10), and a PCI Express ×1 slot 24 electrically connected to the PCI Express ×1 slot circuit 20 (Similarly, where the PCI Express ×1 slot circuit 20 is installed on the main board 10 is the location where the PCI Express ×1 slot 24 is installed on the main board 10).

The ×16 resistor-capacitor circuit 26 comprises a first end 30 electrically connected to the PCI Express ×16 slot circuit 18 via an ×16 conduction segment 38, and a second end 32 electrically connected to the north bridge circuit 14. A plurality of resistors and capacitors (not shown) are electrically connected between the first end 30 and the second end 32 and are installed on the location where the ×16 resistor-capacitor circuit 26 is installed on the main board 10. The ×1 resistor-capacitor circuit 28 comprises a first end 34 electrically connected to the PCI Express ×1 slot circuit 20 via an ×1 conduction segment 40, and a second end 36 electrically connected to the south bridge circuit 16. Another plurality of resistors and capacitors (not shown) are electrically connected between the first end 34 and the second end 36 and are installed on the location where the ×1 resistor-capacitor circuit 28 is installed on the main board 10.

The PCI Express ×16 slot 22 is installed for accommodating PCI express ×16 cards demanding high data transmission rate, such as a PCI express ×16 graphic card. The PCI Express ×1 slot 24 is installed for accommodating PCI express ×1 cards demanding low data transmission rate, such as a PCI express ×1 Ethernet card. The north bridge circuit 14 directs the data transmission between the CPU 12 and any PCI express ×16 cards inserted into the PCI Express ×16 slot 22 via a data transmission path consisting of the ×16 resistor-capacitor circuit 26, the ×16 conduction segment 38, and the PCI Express ×16 slot circuit 18. The south bridge circuit 16 directs the data transmission between the CPU 12 and any PCI express ×1 cards inserted into the PCI Express ×1 slot 24 via another data transmission path consisting of the ×1 resistor-capacitor circuit 28, the ×1 conduction segment 40, and the PCI Express ×1 slot circuit 20.

Both of the PCI Express ×16 slot 22 and the PCI Express ×1 slot 24 have a bottom surface, which is right next to the main board 10 after the PCI Express ×16 slot 22 (and the PCI Express ×1 slot 24 as well) is installed on the main board 10, and an engaging protruding pair installed on the bottom surface. The main board 10, in order to accommodate the PCI Express ×16 slot 22 and the PCI Express ×1 slot 24, has to further comprise two engaging hole pairs respectively corresponding to the engaging protruding pairs of the PCI Express ×16 slot 22 and the PCI Express ×1 slot 24, for respectively accommodating the engaging protruding pairs of the PCI Express ×16 slot 22 and the PCI Express ×1 slot 24 when the bottom surfaces of the PCI Express ×16 slot 22 and the PCI Express ×1 slot 24 are installed on the main board 10. Therefore, the PCI Express ×16 slot 22, and the PCI Express ×1 slot 24 as well, can be fixed onto the main board 10 steadily. Please note that additional engaging holes are neither needed nor allowed to be installed in a region between the engaging hole pair corresponding to the PCI Express ×16 slot 22 on the main board 10.

However, if applied to a computer system, the main board 10 does not have to comprise a PCI express ×16 card and a PCI express ×1 card at the same time. For example, if the computer system has no demand on Internet, the PCI Express ×1 slot 24 installed on the main board 10 applied to the computer system is not required to accommodate the PCI express ×1 Ethernet card. In other words, as far as the computer system is concerned, the PCI Express ×1 slot 24, the PCI Express ×1 slot circuit 20, and even the resistors and capacitors, which are installed on the location where the ×1 resistor-capacitor circuit 28 is installed on the main board 10, are all always left idle and are redundant in practice.

Moreover, as the main board 10 is becoming smaller and smaller in size, even without taking the cost into account, the main board 10 definitely does not have any space spare to accommodate both the PCI Express ×16 slot circuit 18 and the PCI Express ×1 slot circuit 20 at the same time.

### SUMMARY OF INVENTION

It is therefore a primary objective of the claimed invention to provide a main board with a slot-sharing circuit for the PCI Express ×16 slot and the PCI Express ×1 slot to be electrically connected to, so as to reduce the area and the cost of the main board.

According to the claimed invention, the main board, with a slot-sharing circuit for a PCI Express ×16 slot and a PCI Express ×1 slot to be connected to, includes: the slot-sharing circuit, either of the PCI Express ×16 slot and the PCI Express ×1 slot can be installed on a location where the slot-sharing circuit is installed on the main board, and can be electrically connected to the slot-sharing circuit, if being installed on the location; an ×16 resistor-capacitor circuit corresponding to the PCI Express ×16 slot, the ×16 resistor-capacitor circuit having a first end electrically connected to the slot-sharing circuit; an ×1 resistor-capacitor circuit corresponding to the PCI Express ×1 slot, the ×16 resistor-capacitor circuit having a first end electrically connected to the slot-sharing circuit; a slot installed on the location where the slot-sharing circuit is installed on the main board, the slot being electrically connected to the slot-sharing circuit; and a plurality of resistors and capacitors.

The main board further has a north bridge circuit electrically connected to a second end of the ×16 resistor-capacitor circuit, a south bridge circuit electrically connected to a second end of the ×1 resistor-capacitor circuit, and a CPU electrically connected to the north bridge circuit and south bridge circuit.

According to the preferred embodiment, the slot can be either the PCI Express ×16 slot or the PCI Express ×1 slot. If the slot is the PCI Express ×16 slot, the resistors and capacitors are installed in the ×16 resistor-capacitor circuit. On the contrary, if the slot is the PCI Express ×1 slot, the resistors and capacitors are installed in the ×1 resistor-capacitor circuit.

According to a second embodiment of the present invention, the main board further has an ×16 conduction segment corresponding to the PCI Express ×16 slot, the ×16 conduction segment is electrically connected between the first end of the ×1 resistor-capacitor circuit and ×16 resistor-capacitor circuit and the slot-sharing circuit, the ×1 resistor-capacitor circuit is installed on a first side of the main board, and the ×16 resistor-capacitor circuit and the ×16 conduction segment are installed on a second side of the main board. The main board further has a plurality of via-typed contacts installed on a region where the first end of the ×1 resistor-capacitor circuit coincides with the first end of the ×16 resistor-capacitor circuit.

It is an advantage of the claimed invention that either the PCI Express ×16 slot or the PCI Express ×1 slot can be selectively installed on a location where the slot-sharing circuit is installed on the main board, and the resistors and the capacitors can be, in accordance with the installation of the PCI Express ×16 slot and the PCI Express ×1 slot, installed rather in the ×16 resistor-capacitor circuit or in the ×1 resistor-capacitor circuit. The main board therefore costs less. Moreover, since the area occupied by the slot-sharing circuit on the main board of the present invention is equal in size to that occupied by the PCI Express ×16 slot on a prior art main board, the main board of the present invention is smaller in size. Lastly, according to the second embodiment, the installation of the via-typed contacts ensures that the data transmission between the north bridge circuit and a card inserted into the PCI Express ×16 slot, or between the south bridge circuit and a card inserted into the PCI Express ×1 slot, is free from a signal reflection effect.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of a main board according to the prior art.

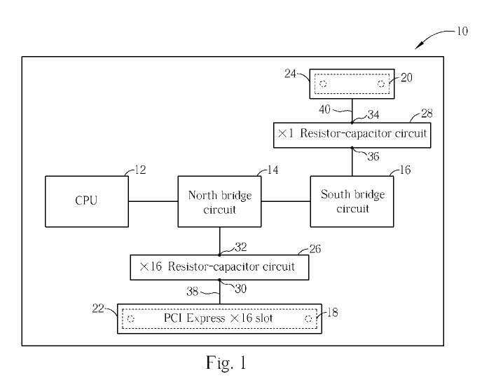

FIG. 2 is a schematic diagram of a main board of the preferred embodiment according to the present invention.

FIG. 3 is a schematic diagram of a main board of a second embodiment according to the present invention.

### DETAILED DESCRIPTION

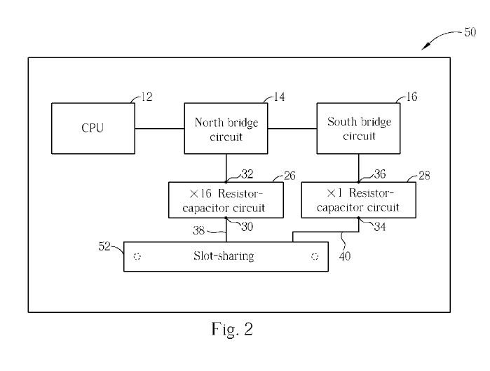

Please refer to FIG. 2, which is a schematic diagram of a main board 50 of the preferred embodiment according to the present invention. In addition to the CPU 12, the north bridge circuit 14, the south bridge circuit 16, the ×16 resistor-capacitor circuit 26, the ×1 resistor-capacitor circuit 28, the ×16 conduction segment 38, and the ×1 conduction segment 40, the main board 50 further comprises a slot-sharing circuit 52 respectively electrically connected to the ×16 resistor-capacitor circuit 26 via the ×16 conduction segment 38 and to the ×1 resistor-capacitor circuit 28 via the ×1 conduction segment 40.

Of the ×16 resistor-capacitor circuit 26, the first end 30 is electrically connected to the slot-sharing circuit 52 via the ×16 conduction segment 38, and the second end 32 is electrically connected to the north bridge circuit 14. Of the ×1 resistor-capacitor circuit 28, the first end 34 is electrically connected to the slot-sharing circuit 52 via the ×1 conduction segment 40, and the second end 36 is electrically connected to the south bridge circuit 16.

According to the preferred embodiment, either of the PCI Express ×16 slot 22 or the PCI Express ×1 slot 24 can be installed on a location where the slot-sharing circuit 52 is installed on the main board 50, and the area occupied by the slot-sharing circuit 52 on the main board 50 is equal in size to the area occupied by the PCI Express ×16 slot circuit 18 on the prior art main board 10. For example, if the PCI Express ×16 slot 22 is installed on the location where the slot-sharing circuit 52 is installed on the main board 50, a location where the ×16 resistor-capacitor circuit 26 is installed on the main board 50 has to be installed with the resistors and capacitors electrically connected between the first end 30 and the second end 32, but another location where the ×1 resistor-capacitor circuit 28 is installed on the main board 50 does not have to be installed with any resistors or capacitors. In such a scenario, the card inserted into the PCI Express ×16 slot 22 can be electrically connected to the north bridge circuit 14 via a data transmission path consisting of the slot-sharing circuit 52, the ×16 conduction segment 38, and the ×16 resistor-capacitor circuit 26. On the other hand, if the PCI Express ×1 slot 24 is installed on the location where the slot-sharing circuit 52 is installed on the main board 50, the another location where the ×1 resistor-capacitor circuit 28 is installed on the main board 50 has to be installed with the resistors and capacitors electrically connected between the first end 34 and the second end 36, but the location where the ×16 resistor-capacitor circuit 26 is installed on the main board 50 does not have to be installed with any resistors or capacitors. In such a scenario, the card inserted into the PCI Express ×1 slot 24 can be electrically connected to the south bridge circuit 16 via a data transmission path consisting of the slot-sharing circuit 52, the ×1 conduction segment 40, and the ×1 resistor-capacitor circuit 28.

As mentioned previously, the main board 10 has to comprise two engaging hole pairs to accommodate the engaging protruding pairs of the PCI Express ×16 slot 22 and the PCI Express ×1 slot 24, so that the PCI Express ×16 slot 22 and the PCI Express ×1 slot 24 can be installed on the main board 10. Similarly, the main board 50 further comprises an engaging hole pair installed on the location where the slot-sharing circuit 52 is installed on the main board 50 for accommodating the engaging protruding pairs of the PCI Express ×16 slot 22 and the PCI Express ×1 slot 24, so that the PCI Express ×16 slot 22 and the PCI Express ×1 slot 24 can be installed on the main board 50.

Please note that since the location where the slot-sharing circuit 52 is installed on the main board 50 can be installed with not only the PCI Express ×16 slot 22, but also the PCI Express ×1 slot 24, whose size is smaller than that of the PCI Express ×16 slot 22, and the main board 50 can not comprise any more engaging holes installed in a region between the existing engaging hole pair, similar to the main board 10, which can not comprise any more engaging holes installed in the region between the engaging hole pair corresponding to the PCI Express ×16 slot 22, the PCI Express ×1 slot 24, if being applied to and installed on the main board 50, can have only a single engaging protruding point.

According to the main board 50 shown in FIG. 2, if the PCI Express ×16 slot 22, for example, is installed on the location where the slot-sharing circuit 52 is installed on the main board 50, data from the north bridge circuit 14 will travel not only to the card inserted into the PCI Express ×16 slot 22 through the resistors and capacitors electrically connected between the first end 30 and the second end 32 of the ×16 resistor-capacitor circuit 26, but also to the first end 34 of the ×1 resistor-capacitor circuit 28 through the ×1 conduction segment 40. The data arrived on the first end 34 of the ×1 resistor-capacitor circuit 28 will be reflected through the ×1 conduction segment 40 to the slot-sharing circuit 52, inducing a signal reflection effect, which will affect the data transmission between the north bridge circuit 14 and the card inserted into the PCI Express ×16 slot 22.

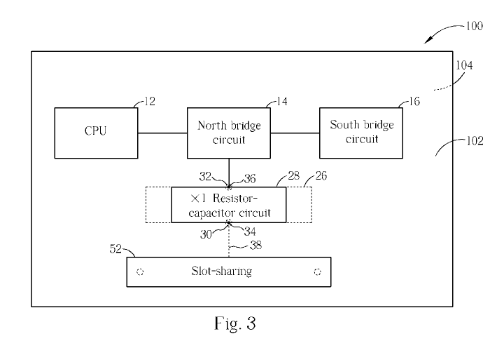

Please refer to FIG. 3, which is a schematic diagram of a main board 100 of a second embodiment according to the present invention. The main board 100, similar to the main board 50, also comprises the CPU 12, the north bridge circuit 14, the south bridge circuit 16, the ×16 resistor-capacitor circuit 26, the ×1 resistor-capacitor circuit 28, and the slot-sharing circuit 52. Different from the main board 50, whose slot-sharing circuit 52 is electrically connected to the first end 30 of the ×16 resistor-capacitor circuit 26 via the ×16 conduction segment 38 and to the first end 34 of the ×1 resistor-capacitor circuit 28 via the ×1 conduction segment 40 at the same time, the main board 100 has the slot-sharing circuit 52 to be electrically connected to the first end 30 of the ×16 resistor-capacitor circuit 26 and to the first end 34 of the ×1 resistor-capacitor circuit 28 both via the ×16 conduction segment 38.

Of the preferred embodiment, the ×16 resistor-capacitor circuit 26, the ×16 conduction segment 38, the ×1 resistor-capacitor circuit 28, and the ×1 conduction segment 40 are all installed on a same side of the main board 50. However, the ×16 conduction segment 38 and the ×1 conduction segment 40 can be installed on two opposite sides of the main board 50. Accordingly, the ×16 resistor-capacitor circuit 26 and the ×1 resistor-capacitor circuit 28 have to be installed on two distinct sides of the main board 50.

As shown in FIG. 3, the ×1 resistor-capacitor circuit 28 is installed on a first side 102 of the main board 100, the ×16 resistor-capacitor circuit 26 is installed on a second side 104 (the ×16 resistor-capacitor circuit 26 is shown as dashed lines in FIG. 3) opposite to the first side 102 on the main board 100, and the ×16 conduction segment 38 is installed on the second side 104 of the main board 100 (the ×16 conduction segment 38 is also shown as dashed lines in FIG. 3). Therefore, if the PCI Express ×1 slot 24, for example, is installed on the location where the slot-sharing circuit 52 is installed on the main board 50, the slot-sharing circuit 52 will not further connect to the ×16 resistor-capacitor circuit 26 via a conduction segment, and data from the south bridge circuit 16 will travel nowhere but through the resistors and capacitors electrically connected between the first end 34 and second end 36 of the ×1 resistor-capacitor circuit 28, and the ×16 conduction segment 38 to the card inserted into the PCI Express ×1 slot 24, without interfered by the signal reflection effect.

Since the ×1 resistor-capacitor circuit 28 and the ×16 resistor-capacitor circuit 26 are installed on the first side 102 and the second side 104 of the main board 100 respectively, and the PCI Express ×16 slot 22 has contacts more than the PCI Express ×1 slot 24 does, the number of contacts of the first end 30 of the ×16 resistor-capacitor circuit 26 being larger than that of contacts of the first end 34 of the ×1 resistor-capacitor circuit 28 accordingly, the contacts on a region that the first end 30 of the ×16 resistor-capacitor circuit 26 coincides with the first end 34 of the ×1 resistor-capacitor circuit 28 have to be via-typed. Therefore, if the PCI Express ×1 slot 24 is installed on the location where the slot-sharing circuit 52 is installed on the main board 100, a card inserted into the PCI Express ×1 slot 24 is electrically connected through a data transmission path consisting of the PCI Express ×1 slot 24, the slot-sharing circuit 52, the ×16 conduction segment 38, which is installed on the second side 104, and the via-typed contacts, to the ×1 resistor-capacitor circuit 28, which is installed on the first side 102. On the other hand, if the PCI Express ×16 slot 22 is installed on the location where the slot-sharing circuit 52 is installed on the main board 100, a card inserted into the PCI Express ×16 slot 22 is electrically connected through another data transmission path consisting of the PCI Express ×16 slot 22, the slot-sharing circuit 52, the ×16 conduction segment 38, and the via-typed contacts and the remaining non-via-typed contacts, to the ×16 resistor-capacitor circuit 26, which is installed on the second side 104.

In contrast to the prior art, the present invention can provide a main board including a slot-sharing circuit, an ×16 resistor-capacitor circuit, an ×1 resistor-capacitor circuit, and a plurality of resistors and capacitors installed in either the ×16 resistor-capacitor circuit or the ×1 resistor-capacitor circuit, depending on whether a PCI Express ×16 slot or a PCI Express ×1 slot is installed on a location where the slot-sharing circuit is installed on the main board. For example, if the PCI Express ×16 slot is installed on the location where the slot-sharing circuit is installed on the main board, in addition to the slot-sharing circuit, the ×16 resistor-capacitor circuit, and the ×1 resistor-capacitor circuit, the main board has to further comprise the resistors and capacitors only, which are installed in the ×16 resistor-capacitor circuit. On the other hand, if the PCI Express ×1 slot is installed on the location where the slot-sharing circuit is installed on the main board, in addition to the slot-sharing circuit, the ×16 resistor-capacitor circuit, and the ×1 resistor-capacitor circuit, the main board has to further comprise the resistors and capacitors only, which are installed in the ×1 resistor-capacitor circuit, instead of the ×16 resistor-capacitor circuit. Therefore, the main board costs less. Moreover, since the area occupied by the slot-sharing circuit of the main board of the present invention is equal in size to that occupied by the PCI Express ×16 slot circuit of the main board of the prior art, the main board of the present invention is smaller is size. Lastly, according to the second embodiment, the installation of the via-typed contacts ensures that the data transmission between the north bridge circuit 14 and a card inserted into the PCI Express ×16 slot 22, or between the south bridge circuit 16 and a card inserted into the PCI Express ×1 slot 24, is free from the signal reflection effect.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A main board with a slot-sharing circuit for a PCI Express ×16 slot and a PCI Express ×1 slot to be connected to, the main board comprising:
the slot-sharing circuit, either of the PCI Express ×16 slot or the PCI Express ×1 slot can be installed on a location where the slot-sharing circuit is installed on the main board, and can be electrically connected to the slot-sharing circuit, if being installed on the location;
an ×16 resistor-capacitor circuit corresponding to the PCI Express ×16 slot, the ×16 resistor-capacitor circuit having a first end electrically connected to the slot-sharing circuit;
an ×1 resistor-capacitor circuit corresponding to the PCI Express ×1 slot, the ×1 resistor-capacitor circuit having a first end electrically connected to the slot-sharing circuit;
a slot installed on the location where the slot-sharing circuit is installed on the main board, the slot being electrically connected to the slot-sharing circuit; and
a plurality of resistors and capacitors.

2. The main board of claim 1, wherein the slot is the PCI Express ×16 slot.

3. The main board of claim 2, wherein all of the resistors and the capacitors are installed in the ×16 resistor-capacitor circuit.

4. The main board of claim 1, wherein the slot is the PCI Express ×1 slot.

5. The main board of claim 4, wherein all of the resistors and the capacitors are installed in the ×1 resistor-capacitor circuit.

6. The main board of claim 1 further comprising an ×16 conduction segment corresponding to the PCI Express ×16 slot, the ×16 conduction segment being electrically connected between the first end of the ×16 resistor-capacitor circuit and the slot-sharing circuit.

7. The main board of claim 6 further comprising an ×1 conduction segment corresponding to the PCI Express ×1 slot, the ×1 conduction segment being electrically connected between the first end of the ×1 resistor-capacitor circuit and the slot-sharing circuit.

8. The main board of claim 7, wherein both of the ×1 conduction segment and the ×16 conduction segment are installed on the same side of the main board.

9. The main board of claim 8, wherein the ×1 resistor-capacitor circuit, the ×16 resistor-capacitor circuit, ×16 conduction segment and the ×1 conduction segment are installed on the same side of the main board.

10. The main board of claim 7, wherein the ×1 conduction segment and the ×16 conduction segment are installed on two distinct sides of the main board respectively.

11. The main board of claim 10, wherein the ×1 conduction segment and the ×1 resistor-capacitor circuit are installed on a first side of the main board, and the ×16 conduction segment and the ×16 resistor-capacitor circuit are installed on a second side of the main board.

12. The main board of claim 1 further comprising:
a north bridge circuit electrically connected to the ×16 resistor-capacitor circuit; and
a south bridge circuit electrically connected to the ×1 resistor-capacitor circuit.

13. A main board with a slot-sharing circuit for a PCI Express ×16 slot and a PCI Express ×1 slot to be connected to, the main board comprising:
the slot-sharing circuit, either of the PCI Express ×16 slot or the PCI Express ×1 slot can be installed on a location where the slot-sharing circuit is installed on the main board, and can be electrically connected to the slot-sharing circuit, if being installed on the location;
an ×16 resistor-capacitor circuit corresponding to the PCI Express ×16 slot, the ×16 resistor-capacitor circuit having a first end electrically connected to the slot-sharing circuit;
an ×1 resistor-capacitor circuit corresponding to the PCI Express ×1 slot, the ×1 resistor-capacitor circuit having a first end electrically connected to the slot-sharing circuit;
a slot installed on the location where the slot-sharing circuit is installed on the main board, the slot being electrically connected to the slot-sharing circuit; and
an ×16 conduction segment corresponding to the PCI Express ×16 slot, the ×16 conduction segment being electrically connected between the first end of the ×16 resistor-capacitor circuit and the slot-sharing circuit;
a plurality of resistors and capacitors.

14. The main board of claim 13, wherein the ×1 resistor-capacitor is installed on a first side of the main board, and the ×16 resistor-capacitor circuit and the ×16 conduction segment are installed on a second side of the main board.

15. The main board of claim 14, wherein the first end of the ×1 resistor-capacitor circuit are installed coinciding with the first end of the ×16 resistor-capacitor circuit.

16. The main board of claim 15, wherein the ×1 resistor-capacitor circuit comprises a plurality of via-typed contacts disposed on a region where the first end of the ×1 resistor-capacitor circuit coincides with the first end of the ×16 resistor-capacitor circuit.

17. The main board of claim 13, wherein the slot is the PCI Express ×16 slot.

18. The main board of claim 17, wherein all of the resistors and the capacitors are installed in the ×16 resistor-capacitor circuit.

19. The main board of claim 13, wherein the slot is the PCI Express ×1 slot.

20. The main board of claim 19, wherein all of the resistors and the capacitors are installed in the ×1 resistor-capacitor circuit.
